(19) United States
(12) Patent Application Publication
(10) Pub. No.: US 2020/0209197 A1
(43) Pub. Date: Jul. 2, 2020

(54) A HOLDING ARRANGEMENT FOR AN ACOUSTIC TRANSMITTER IN AN ACOUSTIC SPECTROSCOPY SYSTEM

(71) Applicant: Acosense AB, GÖTEBORG (SE)

(72) Inventors: Johannes S. KOCHER, TORSLANDA (SE); Lars HANSSON, GÖTEBORG (SE)

(73) Assignee: Acosense AB, GÖTEBORG (SE)

(21) Appl. No.: 16/623,450

(22) PCT Filed: Jun. 19, 2018
(86) PCT No.: PCT/SE2018/050643

§ 371 Date: Dec. 17, 2019

(30) Foreign Application Priority Data
Jun. 20, 2017 (SE) 1750793-0

(51) Int. Cl. G01N 29/22; G01N 29/036; G10K 11/162; G10K 11/00

(52) U.S. Cl. CPC G01N 29/223; G01N 29/036; G10K 11/004; G10K 11/162; G01N 29/222

(57) ABSTRACT

A holding arrangement for holding an acoustic transmitter in place in relation to a container. The arrangement comprises: a body comprising a cavity for holding an acoustic transmitter, the cavity comprising an opening arranged to face said container when said arrangement is attached to a container, wherein the body comprises acoustic damping material, and wherein the cavity is configured to permit movement of an acoustic transmitter in a direction perpendicular to a container surface and to restrict movement of the acoustic transmitter in directions not perpendicular to the container surface when an acoustic transmitter is arranged in said cavity and when said arrangement is attached to a container. There is also provided a measurement arrangement comprising such a holding arrangement.

### FIELD OF THE INVENTION

The present invention relates to a holding arrangement for an acoustic transmitter in an acoustic spectroscopy system. In particular, the invention relates to a holding arrangement configured to protect an acoustic transmitter from external disturbances.

### BACKGROUND OF THE INVENTION

Active Acoustic Spectroscopy is a measurement technique used to analyze fluids inside of a container or containment such as a pipe or a vat. The technique is currently mainly used in the process industry. The technique requires small sensors with high precision in order achieve measurements with sufficient quality in the process industry.

However, when measuring and analyzing properties of fluids/solids/gases from the outside of containers like pipes or vats by using vibration, acoustic and ultrasound techniques, there are many external influences that decrease the accuracy of the measurement. In particular, surrounding process noise can result in a significantly decreased signal to noise ratio in and around the container. Continuous noise sources such as process related noise, including vibration and sound, from pumps, valves, cones and the like may exist which affect the measurement over a long period of time. There are effects influencing the measurements over a medium time span, like temperature shifts that can affect the measurement negatively. There are also short term effects like an impulse due to an object falling on the container and/or the sensor itself that will affect the measurement negatively. In order to accurately detect the desired fluid properties effectively and stable over a long period of time, stability of the acoustic input signal is required independent of external factors like temperature, surrounding noise, dirt etc.

Due to its size, there is also a risk for the sensors to be exposed to dirt, sticky fluids and mechanical stress in the process industry, reducing functionality or destroying the measurement set up.

It is therefore desirable to have the sensors protected, to be resistant against external noise sources so that the sensor can have an as wide as possible useable frequency range to characterize the fluid properties.

### SUMMARY

In view of above-mentioned and other drawbacks of the prior art, it is an object of the present invention to provide a holding arrangement for holding an acoustic transmitter, such as a piezoelectric actuator or an electro-dynamic shaker, which provides a protected environment for the transmitter, thereby reducing the influence of noise and other external environmental parameters, and also self-induced noise.

According to a first aspect of the invention, there is provided a holding arrangement for holding an acoustic transmitter in place in relation to a container. The arrangement comprises: a body comprising a cavity for holding an acoustic transmitter, the cavity comprising an opening arranged to face said container when said arrangement is attached to a container, wherein the body comprises acoustic damping material, and wherein the cavity is configured to permit movement of an acoustic transmitter in a direction perpendicular to a container surface and to restrict movement of the acoustic transmitter in directions not perpendicular to the container surface when an acoustic transmitter is arranged in said cavity and when said arrangement is attached to a container.

That the body comprises acoustic damping material means that the body may be wholly or partially made from a material having acoustic damping, or that the body comprises portions, elements or pieces which are made from such a material. The body may for example comprise several elements where some of the elements are made from an acoustic damping material and where some are not. Acoustic damping is defined by the energy loss in the material as a function of frequency, where a high energy loss equals high damping. The concept of acoustic damping can be applied for sound propagation, vibrations, and more generally, mechanical waves.

The operation of the acoustic transmitter is based on vibrations to generate an acoustic signal aimed at the container. Accordingly, the acoustic transmitter is permitted to move in a direction perpendicular to a container wall in order to generate and transmit acoustic signals, while prevented from moving in other directions which can be described as sideway in relation to the transmission direction.

The present invention is based on the realization that the quality of an acoustic spectroscopy measurement can be improved by means of the above described holder arrangement which reduces the undesired environmental influences and noise negatively influencing the analysis of a gas, fluid, or solid inside a container. In particular, the configuration of the cavity along with the acoustic damping material of the body protects the acoustic transmitter. Moreover, the holder arrangement reduces disturbances reaching the transmitter via the connection between the emitter and the container, which in turn are caused by external influences. It should also be noted that acoustic damping and vibration damping in many cases can be considered to be equivalent in that low frequency vibrations in the audible range often gives rise to sound. Accordingly, acoustic damping and vibration damping can in many cases be seen as equivalent throughout the present description. In particular, an acoustic damping material can be considered to reduce vibrations having frequencies in the acoustic range, and a vibration damping material can be considered to reduce acoustic signals.

Moreover, by restricting lateral movement of the acoustic transmitter, i.e. movement in a direction not perpendicular to the container surface, the overall measurement can be more controlled. In particular, lateral movement of the transmitter decreases the force transmitted towards the container by an increase in undesirable torsional and bending forces. Lateral movement of the transmitter may also cause bad repeatability in measurements and analysis.

An additional advantage of the described holder arrangement is that it acoustically, but not mechanically, uncouples the acoustic transmitter from the object under study, which may be a container of any type in which a gas, fluid, solid is held or flows through. Thereby, the influence of the measurement system and of the transmitter itself is minimized. When attaching a measurement system to a system under study, such as the described container, the properties of the measurement system will be altered. This effect can be detrimental for the measurement results, and should be avoided, or minimized, rather. If not, the measurement system itself can be dominating the measured response, thus leading to a false analysis. Accordingly, it is advantageous to decouple the acoustic transmitter from the container while providing sufficient structural stability, including stiffness, rigidity and strength, to fully support, and to restrict unwanted movement of the acoustic transmitter.

According to one embodiment of the invention, the body of the holding arrangement may comprise portions filled with an acoustic damping material different from a material of said body. Since some portions of the body, such as the main portion of the body comprising the cavity for holding an acoustic transmitter, must have sufficient mechanical stability, soft or flexible acoustic damping materials being may not be possible to use for the entire body. However, by forming openings in the body, such openings can be filled with any desirable acoustic damping material, thereby improving the overall acoustic damping properties of the holder. Examples of acoustic damping materials which could be used in the openings include epoxy-based materials and liquid polymers.

According to one embodiment of the invention, the holding arrangement may further comprise a damping element comprising acoustic damping material attached to an outside of said body. Thereby additional damping of both sound and vibrations can be achieved. Moreover, the damping properties of the holder arrangement can be tailored to the specific requirements of a particular installation by means of one or more additional damping elements connected to the outside of the body, without compromising the structural performance of the holding arrangement.

According to one embodiment of the invention, the body of the holding arrangement may advantageously be made from a material selected from the group comprising, fiber-reinforced polymers, metal powder infused polymers and epoxy infused high porosity metal matrices. All of the aforementioned materials possess advantageous acoustic damping properties and suitable structural properties and are also possible to manufacture and process to achieve the desired shape of the body. The body may for example be manufactured using different 3D printing methods. The body can also be made using casting, injection molding, sintering, or it can be machined directly from a solid block. It is also possible to form a body from multiple separate parts.

According to one embodiment of the invention, the holding arrangement may further comprise fastening means configured to secure an acoustic transmitter in said cavity. Thereby, the acoustic transmitter is prevented from leaving the cavity once secured by the fastening means. The fastening means may for example comprise any type of known arrangement which can be used to compress the portion of the body comprising the cavity such that the sidewalls of the cavity clamp the transmitter in the cavity. Such fastening means may for example comprise screws attached to or reaching through the body, a clasp, a hose clamp and the like. An additional advantage of a fastening arrangement which clamps the acoustic transmitter in the cavity is that movement of the transmitter in directions not perpendicular to the opening of the cavity, and thereby perpendicular to a surface of a container, is further restricted.

According to one embodiment of the invention, a sidewall of the cavity may advantageously comprise vibration damping material such that vibration damping material is located between an acoustic transmitter and the sidewall wall when an acoustic transmitter is arranged in the cavity. Thereby, further reduction of vibrations reaching the acoustic transmitter can be achieved. A vibration damping material may advantageously be arranged on all sidewalls of the cavity so as to surround the transmitter, thereby maximizing the vibration damping, while minimizing unwanted structural weakening.

According to one embodiment of the invention, the vibration damping material may be an elastomer which provides advantageous vibration damping properties as well as being available in many different compositions, thereby making it possible to adapt the vibration damping properties of the holding arrangement according to the specific requirements of a selected installation. However, other materials with similar properties can equally well be used.

According to one embodiment of the invention, the body may further comprise a trench arranged adjacent to the cavity and reaching a sidewall of the cavity on at least one side of said cavity such that the cavity is connected to the trench. The trench may be configured so that a degree of flexibility is introduced in the region of the body comprising the cavity in order to facilitate securing of the transmitter in the cavity using any of the above described fastening means. Accordingly, the trench may extend into the body from opposing sides of the cavity. The trench may also have a depth which is the same as the depth of the cavity.

According to one embodiment of the invention, the trench may advantageously be filled with an acoustic damping material. Thereby, the trench improves the overall damping properties of he body as well as facilitates clamping of the transmitter in the cavity as described above.

According to one embodiment of the invention, the holding arrangement may further comprise at least one connecting portion attached to the body and configured to be in contact with said container. Thereby, the connection portion may be adapted to fit with a specific container to which the holding arrangement is to be connected without the need to modify or redesign the entire body of the holding arrangement.

According to one embodiment of the invention, the connecting portion may advantageously be a connection element releasably connected to the body. Thereby, the holding arrangement can be provided as a modular holding arrangement with exchangeable connection elements so that only the connection element needs to be adapted for a specific container. This greatly increases usability of the holding arrangement since it can easily be used in a wide range of applications.

According to one embodiment of the invention, the connecting portion may advantageously be curved having a curvature corresponding to a curvature of a container to which said arrangement is to be connected, thereby providing a robust mechanical coupling to the container.

According to one embodiment of the invention, the connecting portion may comprise an acoustic damping element located on a side of the connecting portion configured to be connected to a container, thereby reducing the amount of vibrations reaching the acoustic transmitter from the container via the body of the holding arrangement. The container itself may for example propagate sound or vibrations which may disturb the transmitter and the transmitted acoustic signal. The acoustic damping element may also prevent a transmitted acoustic signal from propagating back into the body of the holding arrangement via the container.

According to one embodiment of the invention, the cavity may advantageously be a cylindrical cavity, thereby having a circular cross section. Thereby, a corresponding cylindrical acoustic transmitter can easily be placed in the cylindrical cavity having a maximum contact surface against the cavity walls to reduce movement of the transmitter in other directions than along the central axis of the cylindrical cavity. However, it should be noted other shaped cavities are also possible as long as the same or similar performance of the transmitter can be achieved.

According to one embodiment of the invention, the holding arrangement may further comprise an acoustic transmitter arranged in the cavity, the acoustic transmitter being configured to transmit an acoustic signal along an axial direction of the cavity.

There is also provided an acoustic measurement arrangement comprising a container, a holding arrangement for holding an acoustic transmitter according to any one of the aforementioned embodiments and an acoustic transmitter arranged in the cavity of the arrangement, wherein the arrangement is attached to the container.

The container may for example be a pipe having a certain curvature, where a material flowing through the pipe is being analyzed by means of acoustic spectroscopy. However, the container may be of any form or shape.

Further features of, and advantages with, the present invention will become apparent when studying the appended claims and the following description. The skilled person realize that different features of the present invention may be combined to create embodiments other than those described in the following, without departing from the scope of the present invention.

### BRIEF DESCRIPTION OF THE DRAWINGS

These and other aspects of the present invention will now be described in more detail, with reference to the appended drawings showing an example embodiment of the invention, wherein:

FIG. 1 schematically illustrates a holding arrangement according to an embodiment of the invention;

FIGS. 2A-B schematically illustrate a holding arrangement according to an embodiment of the invention;

FIG. 3 schematically illustrates an element of a holding arrangement according to an embodiment of the invention;

FIGS. 4A-B schematically illustrate elements of a holding arrangement according to an embodiment of the invention; and

FIGS. 5A-B schematically illustrate a measurement arrangement comprising a holding arrangement according to an embodiment of the invention.

### DETAILED DESCRIPTION OF EXAMPLE EMBODIMENTS

In the present detailed description, various embodiments of the holding arrangement according to the present invention are mainly described with reference to a holding arrangement configured to be mounted onto a pipe.

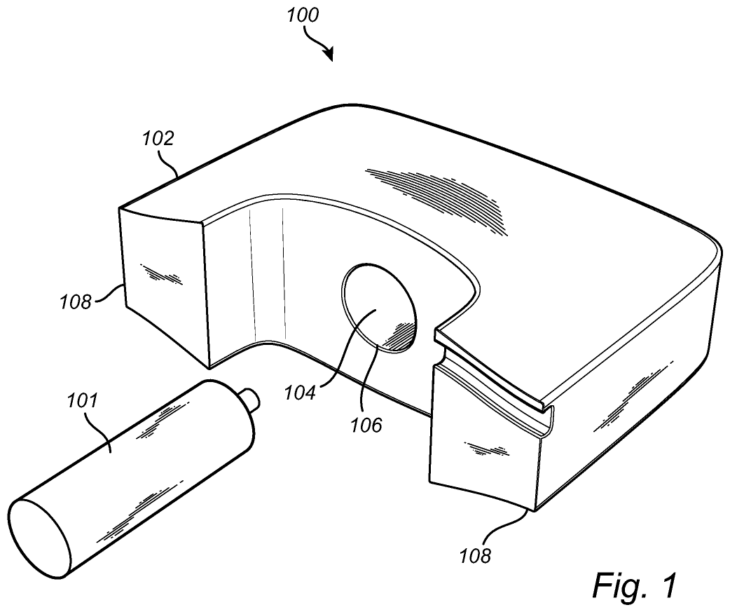

FIG. 1 is a schematic illustration of a holding arrangement 100 for holding an acoustic transmitter 101 in place in relation to a container. The holding arrangement comprises a body 102 which in turn comprising a cavity 104 for holding an acoustic transmitter 101. The cavity comprises an opening 106 arranged and configured to face the container when the arrangement is attached to a container. Moreover, the connection portions 108 of the holding arrangement are arranged to be in contact with the container. The illustrated the connection portions 108 may also be referred to as legs or feet, and the shape and configuration of the connecting portions can be adapted to fit the container to which the holding arrangement 100 is to be attached.

The body 102 of the holding arrangement 100 is made from an acoustic damping material. Other desirable properties of the body of the holding arrangement are high stiffness, a high loss factor/damping, and a wide operating temperature range.

The cavity 104 adapted to house the acoustic transmitter 101 is further configured to permit movement of an acoustic transmitter in a direction perpendicular to a container surface and to restrict movement of the acoustic transmitter in directions not perpendicular to the container surface when an acoustic transmitter is arranged in cavity and when the arrangement is attached to a container. For a cylindrical transducer, this means that the diameter of the cavity 104 is only slightly larger than the diameter of the transducer, such that the transducer can be inserted into the cavity 104 but without it being able to mode laterally once inserted.

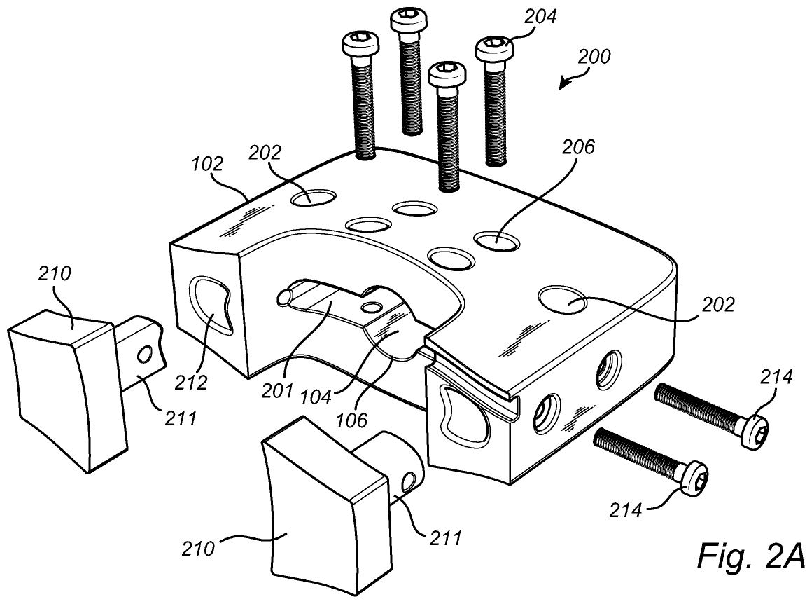

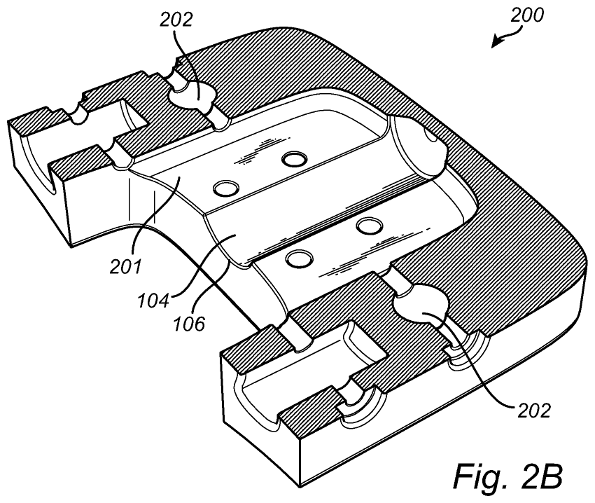

FIG. 2A schematically illustrates a holding arrangement 200 according to another embodiment of the invention. The holding arrangement 200 comprises cutouts 202 in the body which may be filled with an acoustic damping material different form the material of the body 102. The acoustic damping material used in the cutouts may for example be a material which has advantageous damping properties but which is not mechanically rigid, such as rubber or silicone based materials.

The holding arrangement 200 of FIG. 2A further comprises a trench 201 arranged in the body 102 adjacent to the cavity 104 such that the cavity 104 is connected to the trench 201. The trench 201 extends on both sides of the cavity 104, although it should be understood that the trench 201 can be arranged in various ways. The trench 201 can be filled with a damping material to further reduce vibrations.

The holding arrangement 200 of FIG. 2A further comprises fastening means in the form of bolts 204 configured to secure the acoustic transmitter 101 in the cavity 104. The bolts 204 are inserted into openings 206 of the body 102 and secured by using corresponding nuts (not shown) on the opposing side of the body 102. By means of the trench 104, a degree of flexibility is introduced in the sidewalls of the body 102, facilitating compression of the body to secure the transmitter 101 in the cavity 104 once the nuts and bolts are tightened. The skilled person realizes that many different types of fastening means are possible, such as tensioners, clamps and the like. It is also possible to secure the transmitter 101 in the cavity 104 using an adhesive material.

FIG. 2A further illustrates a connection element 210 which can be releasably attached to the body 102. The connection element 210 is attached to the body 102 by inserting a connecting portion 211 of the connection element 210 into a corresponding opening 212 of the body 102 where it can be secured e.g. by a bolt 214. It should be noted that many different types of securing means are feasible other than the described bolt, and that the illustrated embodiment merely describes an example configuration.

FIG. 2B is a cross section of the holding arrangement 200 illustrated in FIG. 2A. Here, it can more clearly be seen that the cylindrical cavity 104 extends into the body 102 of the holding arrangement 200. It can also be seen that the trench 201 extends to the same extent as the cavity for holding the transmitter such that a damping material may be arranged along the entire length of the transmitter 101 if desirable.

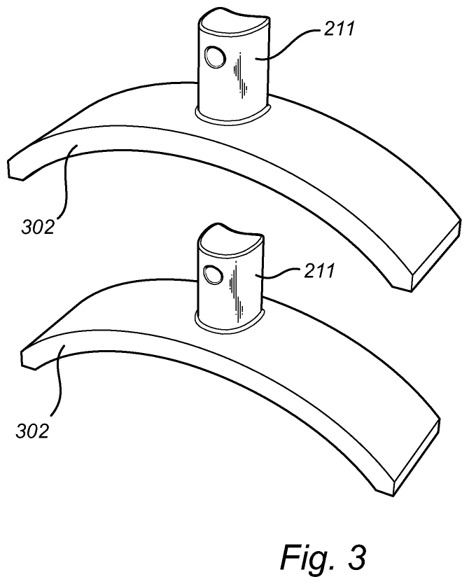

FIG. 3 illustrates an alterative configuration of a connection element 302 which is adapted to be connected to a pipe, where the curvature of the connection element 302 is configured to match the curvature of the pipe. The curved portions of the connection element 302 may also be flexible to allow attaching the same connection element 302 to pipes of different diameter. Thereby, only the connection element 302 needs to be changed or adapted to facilitate connection of the holding arrangement 200 to practically any type of container. There may also be additional damping material located between the connection element 302 and the container.

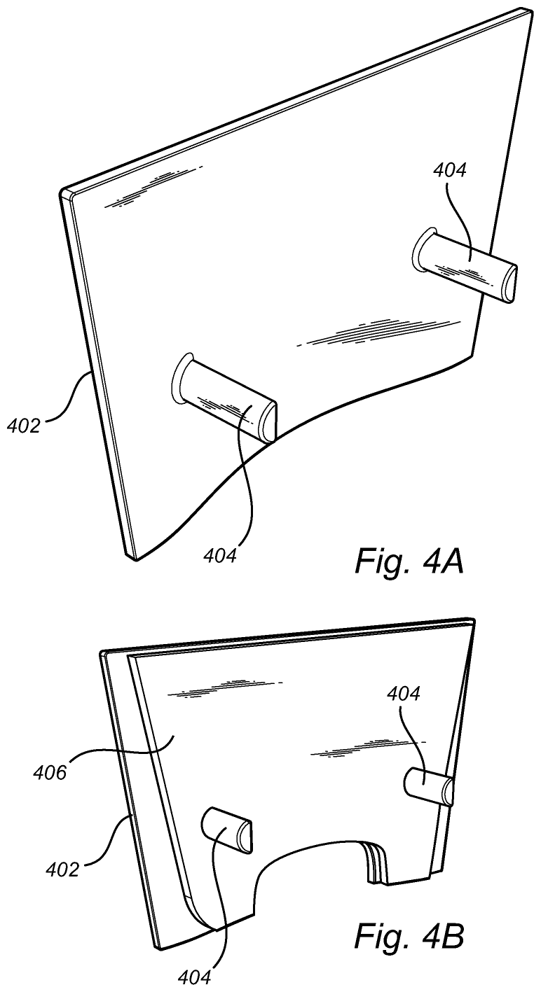

FIGS. 4A-B illustrate an acoustic damping element 402 to be attached to the body 102 of the holding arrangement 200. The damping element 402 may further comprise a sheet 406 of acoustic and/or vibration damping material as illustrated in FIG. 4B. The damping element 402 further comprises pins 404 used to attach the sheet of damping material 406 illustrated in FIG. 4B. It is also possible to attach the sheet 406, or a similarly shaped piece of material, using an adhesive. The pins 404 may also be used to attach the damping element 402 to the body 102 by insertion in corresponding openings 202. Accordingly, the damping element 402 may be connected using openings 202 which may also comprise a damping material. However, the damping element 402 may be attached to the body 102 of the holding arrangement in any suitable manner, e.g. using screws, tensioners adhesives etc.

The damping element 402 may for example be made from the same material as the body 102 such that it is sufficiently rigid to mechanically protect the body 102 and a transmitter 101 arranged in the body 102. The sheet 404 of damping material, and the damping material used in cutouts of the body, may comprise an elastomer (e.g. silicone), which fulfils the mechanical and acoustical requirements such as damping in frequency range of interest, durability in the relevant temperature range, long-term stability, etc. The additional damping material may advantageously have higher damping factor. Moreover, several layers, or sheets 404, of damping material can be used between the damping element and the body 102.

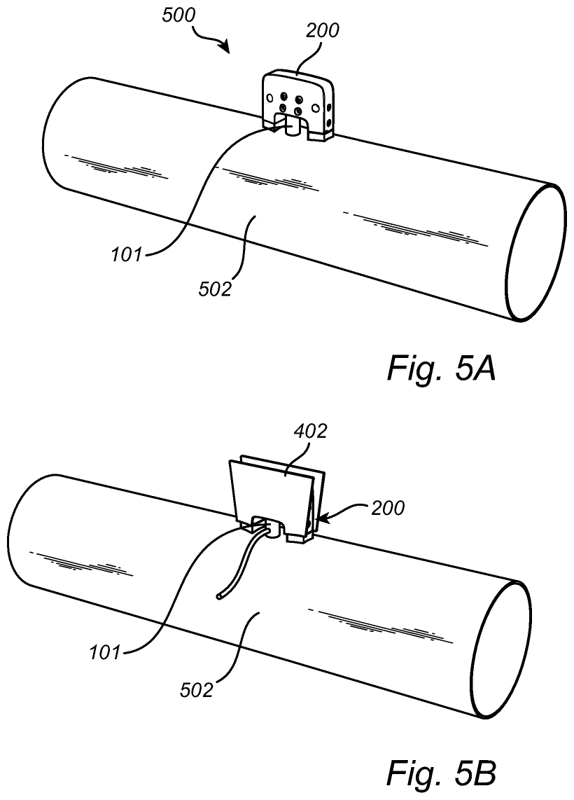

FIG. 5A schematically illustrates an acoustic measurement arrangement 500 comprising a container 502 in the form of a pipe 502, a holding arrangement 200 with an acoustic transmitter 101 arranged in the cavity 104 of the holding arrangement 200. The holding arrangement is attached to the container 502 by means of the connection elements 210. The connection element may for example be connected to corresponding receiving elements which may be glued or otherwise attached to the container 502. It is also possible to use hose clamps in combination with the connection elements 210 for attaching the holding arrangement 200 to the container 502. The acoustic transmitter 101 is configured to transmit an acoustic signal along an axial direction of the cavity 104 and into the container 502 through the container wall.

FIG. 5B illustrates a similar acoustic measurement arrangement but with the external damping element 104 attached to the holding arrangement 200.

An acoustic receiver for receiving the signal transmitted by the transmitter 101 can be located in any location, depending on the setup, obstructions etc., as long as it can be properly and securely mounted. The receiver should be sufficiently close to the transmitter 101 to achieve a good SNR (signal-to-ratio), but far enough from the excitation point (i.e. the transmitter) to be distinguishable.

By means of the described holding arrangement and a resulting measurement arrangement, the signal to noise ratio of an acoustic gas/fluid/solid analysis can be significantly increased by constraining unwanted movement of the acoustic transmitter in all other directions than towards the test object.

Even though the invention has been described with reference to specific exemplifying embodiments thereof, many different alterations, modifications and the like will become apparent for those skilled in the art. Also, it should be noted that parts of the holding arrangement may be omitted, interchanged or arranged in various ways, the holding arrangement yet being able to perform the functionality of the present invention.

Additionally, variations to the disclosed embodiments can be understood and effected by the skilled person in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage.

1. A holding arrangement for holding an acoustic transmitter in place in relation to a container, the arrangement comprising:
a body comprising a cavity for holding an acoustic transmitter, the cavity comprising an opening arranged and configured to face said container when said arrangement is attached to a container, wherein the body is made from an acoustic damping material, and wherein the cavity is configured to permit movement of an acoustic transmitter in a direction perpendicular to a container surface and to restrict movement of the acoustic transmitter in directions not perpendicular to the container surface when an acoustic transmitter is arranged in said cavity and when said arrangement is attached to a container.

2. The holding arrangement according to claim 1, wherein the body comprises portions filled with an acoustic damping material different from a material of said body.

3. The holding arrangement according to claim 1, further comprising a damping element comprising acoustic damping material attached to an outside of said body.

4. The holding arrangement according to claim 1, wherein the body is made from a material selected from the group comprising, fiber-reinforced polymers, metal powder infused polymers and epoxy infused high porosity metal matrices.

5. The holding arrangement according to claim 1, further comprising fastening means configured to secure an acoustic transmitter in said cavity.

6. The holding arrangement according to claim 1, wherein a sidewall of said cavity comprises vibration damping material such that vibration damping material is located between an acoustic transmitter and said sidewall wall when an acoustic transmitter is arranged in said cavity.

7. The holding arrangement according to claim 6, wherein the vibration damping material is an elastomer.

8. The holding arrangement according to claim 1, wherein said body further comprises a trench arranged adjacent to said cavity and reaching a sidewall of said cavity on at least one side of said cavity such that said cavity is connected to said trench.

9. The holding arrangement according to claim 8, wherein said trench is filled with an acoustic damping material.

10. The holding arrangement according to claim 1, further comprising at least one connecting portion attached to said body and configured to be in contact with said container.

11. The holding arrangement according to claim 10, wherein said connecting portion is a connection element releasably attached to said body.

12. The holding arrangement according to claim 10, wherein said connecting portion is curved having a curvature corresponding to a curvature of a container to which said arrangement is to be connected.

13. The holding arrangement according to claim 10, wherein said connecting portion comprises an acoustic damping element located on a side of said connecting portion configured to be connected to a container.

14. The holding arrangement according to claim 1, further comprising an acoustic transmitter arranged in said cavity, said acoustic transmitter being configured to transmit an acoustic signal along an axial direction of said cavity.

15. An acoustic measurement arrangement comprising:
a container;
a holding arrangement for holding an acoustic transmitter according to claim 1; and
an acoustic transmitter arranged in said cavity of said holding arrangement, wherein said holding arrangement is attached to said container.
